(19) United States
(12) Patent Application Publication
(10) Pub. No.: US 2015/0305075 A1
(43) Pub. Date: Oct. 22, 2015

(54) Neighbor Discovery in Device-to-Device Communications

(71) Applicant: Telefonaktiebolaget L M Ericsson (publ), Stockholm (SE)

(72) Inventors: Gabor Fodor, Hässelby (SE); Marco Belleschi, Solna (SE); Bengt Lindoff, Bjärred (SE); Leif Wilhelmsson, Dalby (SE)

(73) Assignee: Telefonaktiebolaget L M Ericsson (publ), Stockholm (SE)

(21) Appl. No.: 14/438,906

(22) PCT Filed: Nov. 5, 2012
(86) PCT No.: PCT/SE12/51198

§ 371 Date: Apr. 28, 2015

(51) Int. Cl. H04W 76/02; H04W 68/00; H04W 8/00

(52) U.S. Cl. CPC H04W 76/023; H04W 8/005; H04W 68/00

(57) ABSTRACT

In device-to-device (D2D) communications underlying a cellular telecommunication infrastructure, a neighbor discovery of D2D-enabled user equipments (UEs) is performed on the basis of a Cell Radio Network Temporary Identifier, CRNTI. Hereby it is made possible to provide for D2D neighbor discovery for a relatively large number of D2D-enabled user equipments (UEs).

### TECHNICAL FIELD

Embodiments of the present invention presented herein generally relate to the field of telecommunication. The present disclosure describes methods, radio network nodes and user equipments (UEs) which are operable in device-to-device (D2D) communication. More particularly, the present disclosure presents technology to provide an alternative neighbor discovery in D2D communication.

### BACKGROUND

This section is intended to provide a background to the various embodiments of the present invention that are described in this disclosure. The description herein may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In recent years, efforts have been made on the development of Third Generation Partnership Project (3GPP) Long Term Evolution (LTE), which provides Evolved Universal Mobile Telecommunications System (UMTS) terrestrial radio access (EUTRA) and EUTRA network (E-UTRAN) technology for achieving higher data rates and system capacity. Also, efforts have been put on the System Architecture Evolution (SAE) for achieving efficient networking and cost saving operation.

Recently, device-to-device (D2D) communication as an underlay to a cellular telecommunication network has been proposed as a means of taking advantage of the physical proximity of communicating user equipments (UEs), increasing resource utilization, and improving cellular coverage. In D2D communication, the traffic of UEs is transmitted directly between the UEs, while the traffic transmission is controlled by radio network nodes such as evolved NodeBs (abbreviated eNBs). In D2D communication the random access, authorization, resource provision, charging, etcetera are controlled by the eNBs. Therefore, D2D communication is also sometimes referred to as cellular-controlled D2D communication or network assisted D2D communication. Sometimes, D2D communication is also referred to as “LTE Direct” among persons skilled in the art.

D2D communication supported by a cellular telecommunication infrastructure provides for certain advantages. First, the proximity of UEs may allow for high bit rates, low delays and low power consumption. Secondly, radio resources may be simultaneously used by cellular as well as D2D communication links, which provides for an efficient use of resources. Thirdly, in D2D a single link is used in D2D mode rather than using both an uplink (UL) and a downlink (DL) resource when communicating in cellular mode. Yet further, D2D communication may extend the cellular coverage and facilitate new types of device-to-device services (a.k.a. peer-to-peer services).

However, D2D communication as an underlay to cellular telecommunication networks poses new challenges. One of these challenges is the so-called neighbor discovery. That is, the procedure that allows devices such as UEs in the proximity of each other to detect or discover one another. Neighbor discovery is a challenge in D2D communication, because before two UEs can directly communicate with one another, they must first know (i.e., discover, or detect) that they are sufficiently near each other.

The first step in the establishment of a D2D link is that the network and/or the UEs discover, or detect, the presence of their peer and the UEs are identified as D2D candidates. Neighbor discovery and device pairing are well known procedures in, e.g., Bluetooth, where the so-called inquiry process allows a potential master node to identify devices in range that wish to participate in a piconet, whereas the so-called page process allows the master node to establish links toward desired slave nodes. However, neighbor discovery in D2D communication is still one of the issues that are yet to be solved by improved or alternative techniques.

### SUMMARY

It is in view of the above considerations and others that the various embodiments of the present invention have been made. The inventors have realized that there is a need for improved neighbor discovery in cellular-controlled D2D communication.

To this end, the inventors have also realized that it would be advantageous to provide a D2D neighbor discovery that, at least partly, reuses concepts from the existing LTE cell search while at the same time allows for discovering any UE from a large set of UEs (e.g., a set of UEs comprising more than 504 UEs). This way, the D2D neighbor discovery would resemble the existing LTE cell search by which a UE determines the time and frequency parameters, etc., that are important to demodulate the DL and to determine the cell identity (and, thereby, the UE effectively “discovers”, i.e. detects, the cell). Thereby, a solution with limited complexity is made possible while providing for an alternative and improved way for D2D neighbor discovery.

It is consequently a general object of the various embodiments of the present invention to provide improved methods, UEs and radio network nodes that allow for improved neighbor discovery in cellular-controlled D2D communication.

The various embodiments of the present invention as set forth in the appended independent claims address this general object. The appended dependent claims represent additional advantageous embodiments of the present invention.

According to an aspect, there is provided a method performed by a first user equipment, UE. This method comprises: sending, to a radio network node, a signal comprising a request to initiate device-to-device communication with a second UE; receiving, from the radio network node, a signal comprising a Cell Radio Network Temporary Identifier, CRNTI, of the second UE; receiving, from the second UE, a beacon signal comprising the CRNTI of the second UE; comparing the CRNTI of the second UE received by the radio network node with the CRNTI comprised in the beacon signal received from the second UE; and establishing a device-to-device communication between the first UE and the second UE when the CRNTI of the second UE received by the radio network node matches the CRNTI comprised in the beacon signal received from the second UE.

In some embodiments, the beacon signal received from the second UE comprising the CRNTI further comprises a Primary Synchronization Signal, PSS, and a Secondary Synchronization Signal, SSS.

Furthermore, the signal comprising the CRNTI of the second UE, received from the radio network node, may additionally comprise a request for requesting the first UE to listen for beacon signals from a second UE.

Additionally, the signal sent to the radio network node comprising the request to initiate device-to-device communication with the second UE may comprise an identification of the second UE. This identification may comprise a Mobile Subscriber Integrated Services Digital Network, MSISDN, number. Alternatively, the identification may comprise an International Mobile Subscriber Identity, IMSI, number.

Moreover, the signal sent to the radio network node comprising the request to initiate device-to-device communication with the second UE may additionally, or alternatively, comprise an indicator indicating a type of device-to-device communication. Thus, the indicator may comprise a content ID (identification) and/or a service ID. Such content ID and/or service ID may e.g. be set for instance by a human interface according to a specific subscription profile.

The method may also comprise: receiving a paging message from a radio network node, the paging message comprising a SAE-Temporary Mobile Subscriber Identity, S-TMSI, of the first UE; comparing the S-TMSI of the first UE received by the radio network node with a S-TMSI assigned to the first UE; and sending a paging acknowledgment message to the radio network node when the S-TMSI of the first UE received by the radio network node matches the S-TMSI assigned to the first UE.

The method may optionally also comprise: receiving a paging message from a radio network node, the paging message comprising a content ID and/or a service ID; comparing the content ID and/or service ID received by the network with content ID and/or service ID that the first UE is capable of supporting; and sending a paging acknowledgment message to the radio network node when the content ID and/or service ID received by the radio network node matches the content ID and/or service ID that the first UE can support.

Moreover, the method may comprise sending a beacon signal comprising the CRNTI of the first UE to another UE upon receiving a request from the radio network node requesting the first UE to send said beacon signal. The beacon signal comprising the CRNTI of the first UE may additionally comprise a PSS and a SSS.

According to another aspect, there is provided a user equipment which is configured to execute the method according to the above-mentioned aspect.

According to yet another aspect, there is provided a method performed by a radio network node. This method comprises: receiving, from a first user equipment, UE, a signal comprising a request to initiate device-to-device communication with a second UE, retrieving a Cell Radio Network Temporary Identifier, CRNTI, of the second UE; activating a device-to-device admission control scheme to establish whether a device-to-device communication can take place between the first UE and the second UE; and when the admission control scheme indicates that a device-to-device communication can take place between the first UE and the second UE further comprising sending, to the first UE, a signal comprising a Cell Radio Network Temporary Identifier, CRNTI, of the second UE.

The signal comprising the CRNTI of the second UE which is sent to the first UE further may further comprise a request requesting the first UE to listen for beacon signals from a second UE.

Also, the signal received from the first UE comprising the request to initiate device-to-device communication with the second UE may additionally comprise an identification of the second UE. The identification may comprise a Mobile Subscriber Integrated Services Digital Network, MSISDN, number or an International Mobile Subscriber Identity, IMSI, number.

The signal received from the first UE comprising the request to initiate device-to-device communication with the second UE may additionally comprise an indicator indicating a type of device-to-device communication. The indicator may, in some embodiments, comprise a content ID (identification) and/or a service ID.

Yet further, in some embodiments the method may additionally comprise: retrieving a SAE Temporary Mobile Subscriber Identity, S-TMSI, of the second UE; sending a paging message to the second UE, the paging message comprising the retrieved S-TMSI of the second UE; and receiving a paging acknowledgment message from the second UE; wherein the step of activating the device-to-device admission control scheme is performed when the paging message has been received.

The method may also comprise sending, to the second UE, a signal comprising a request requesting the second UE to transmit a beacon signal comprising a CRNTI of the second UE.

According to a further aspect, there is provided a radio network node, such as an evolved NodeB, which is configured to execute the method according to the above-mentioned aspect.

According to yet another aspect, there is provided a user equipment, comprising a communication interface arranged for wireless communication; a processor; and a memory storing computer program code which, when run in the processor, causes the user equipment to: send, to a radio network node via the communication interface, a signal comprising a request to initiate device-to-device communication with a second UE; receive, from the radio network node via the communication interface, a signal comprising a Cell Radio Network Temporary Identifier, CRNTI, of the second UE; receive, from the second UE via the communication interface, a beacon signal comprising the CRNTI of the second UE; compare the CRNTI of the second UE received by the radio network node with the CRNTI comprised in the beacon signal received from the second UE; and establish, via the communication interface a device-to-device communication between the first UE and the second UE when the CRNTI of the second UE received by the radio network node matches the CRNTI comprised in the beacon signal received from the second UE.

According to still another aspect, there is provided a radio network node, comprising: a communication interface arranged for wireless communication; a processor; and a memory storing computer program code which, when run in the processor, causes the radio network node to: receive, from a first user equipment, UE, via the communication interface, a signal comprising a request to initiate device-to-device communication with a second UE; retrieve a Cell Radio Network Temporary Identifier, CRNTI, of the second UE; activate a device-to-device admission control scheme to establish whether a device-to-device communication can take place between the first UE and the second UE; and when the admission control scheme indicates that a device-to-device communication can take place between the first UE and the second UE also send, to the first UE via the communication interface, a signal comprising a CRNTI of the second UE. In some embodiments, the radio network node is a evolved NodeB.

### BRIEF DESCRIPTION OF THE DRAWINGS

These and other aspects, features and advantages of the invention will be apparent and elucidated from the following description of embodiments of the present invention, reference being made to the accompanying drawings, in which:

FIG. 1 illustrates an exemplary scenario of cellular controlled D2D communication;

FIG. 2 shows a signaling diagram, or flow chart, illustrating an embodiment of D2D neighbor discovery in FIG. 1;

FIG. 3 shows a signaling diagram, or flow chart, illustrating another embodiment of D2D neighbor discovery in FIG. 1;

FIG. 4 is a block diagram of an example embodiment of a user equipment; and

FIG. 5 is a block diagram of an example embodiment of a radio network node (e.g. a eNB); and

FIG. 6 illustrates various message formats that may be used in signals or messages, which are signaled when executing methods according to the various embodiments of the invention.

### DETAILED DESCRIPTION

The invention will now be described more fully hereinafter with reference to the accompanying drawings, in which certain embodiments of the invention are shown. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like numbers refer to like elements throughout the description.

According to the various embodiments disclosed throughout this disclosure, the inventors propose to exploit the Cell Radio Network Temporary Identifier (abbreviated CRNTI or C-RNTI) when performing neighbor discovery between UEs operating in a cellular controlled D2D environment. In other words, the inventors propose a CRNTI-based neighbor discovery in D2D communication. As is known among persons skilled in the art of this disclosure the CRNTI is generally assigned to UEs during the random access procedure. As will be further elaborated with respect to the detailed embodiments hereinafter, using a CRNTI based neighbor discovery of UEs in D2D communication may provide for an alternative and improved neighbor discovery.

According to some embodiments described hereinafter, the D2D discovery procedure can resemble the existing LTE cell search procedure in that parts of the beacon signals used during the procedure according to these embodiments comprise PSS (Primary Synchronization Signal) and SSS (Secondary Synchronization Signal) of the cell in which the UE broadcasting the beacon signals is residing. In other words, the proposed neighbor discovery may have a similar functionality as the so-called cell search in LTE by which the UE determines the time and frequency parameters that are important to demodulate the DL and to determine the cell identity (and, thereby, the UE effectively “discovers”, i.e. detects, the cell). Although the LTE cell search procedure is, as such, known among persons skilled in the art of this disclosure, some aspects of this procedure will be briefly described herein for ease of understanding the later-described embodiments.

LTE Cell Search

Generally, a UE carries out cell search at power-up, i.e., when initially accessing the radio network. Also, to support mobility, UEs continuously search for, synchronize to, and estimate reception quality of neighboring cells. The reception quality of neighboring cells, in relation to the reception quality of the cell where a particular UE is currently residing, can then be evaluated to conclude if a handover (for UEs in connected mode) or a cell reselection (for UEs in idle mode) should be carried out. Generally speaking, the LTE cell search comprises the following basic parts: i) acquire frequency and symbol synchronization to a cell, ii) acquire frame timing of the cell, i.e., determine the start of the DL frame and iii) determine the physical-layer cell identity of the cell. There are 504 different physical-layer cell identities defined for LTE, where each cell identity corresponds to one specific DL reference signal sequence. The set of physical-layer cell identities is further divided into 168 cell-identity groups, with three cell identities within each group. To assist the cell search, two signals are transmitted on the LTE DL, namely the PSS and the SSS.

Although having the same detailed structure, the time-domain positions of the synchronization signals may differ depending on if the cell is operating in TDD (Time Division Duplex) or in FDD (Frequency Division Duplex). In case of FDD, the PSS is transmitted within the last symbol of the first slot of subframes 0 and 5, while the SSS is transmitted within the second last symbol of the same slot, that is just before the PSS. In case of TDD, the PSS is transmitted within the third symbol of subframe 1 and 6, while the SSS is transmitted in the last symbol of subframes 0 and 5 (i.e. three symbyls ahead of the PSS).

The PSS is a specific length-63 Zadoff-Chu (ZC) sequence. There are three different PSS sequences defined and used in LTE. Thus, on a more detailed level, the three PSSs are three length-63 ZC sequences. The ZC sequences are extended with five zeros at the edges and mapped to the center 73 subcarriers. The center subcarrier is actually not transmitted as it coincides with the DC subcarrier. Hence, only 62 elements of the length-63 are actually transmitted. The PSS thus occupies 72 resource elements (not including the DC carrier) in subframes 0 and 5 (FDD) and subframes 1 and 6 (TDD). Once a UE has detected and identified the PSS of a cell, the UE has found the following: 1) 5 ms timing of the cell and thus also the position of the SSS which has a fixed offset relative to the PSS; and 2) the cell identity within the cell identity group. However, the UE has not yet determined the cell identity group itself, i.e. the number of possible cell identities that has been reduced from 504 to 168.

Thus, from the SSS, the position of which is known once the PSS has been detected, the UE should find the following: 1) frame timing and 2) the cell identity group (168 alternatives). Similar to the PSS, SSS occupies 72 resource elements (not including the DC carries) in subframes 0 and 5 (for both FDD and TDD). The two SSS should take their values from sets of 168 possible values corresponding to 168 different cell identity groups. Also, a set of values applicable for the first SSS should be different from the set of values for the second SSS to allow for the frame timing detection from reception of a single SSS. The structure of the two SSS is based on frequency interleaving two length-31 m-sequences, each of which can take 31 different values.

Once a UE has acquired frame timing and physical-layer cell identity, the UE has identified the cell-specific reference signal and can begin channel estimation. The UE can then decode the BCH (Broadcast CHannel) which carries the most basic set of system information.

Embodiments where UEs are Connected in the Same Cell (CONNECTED MODE)

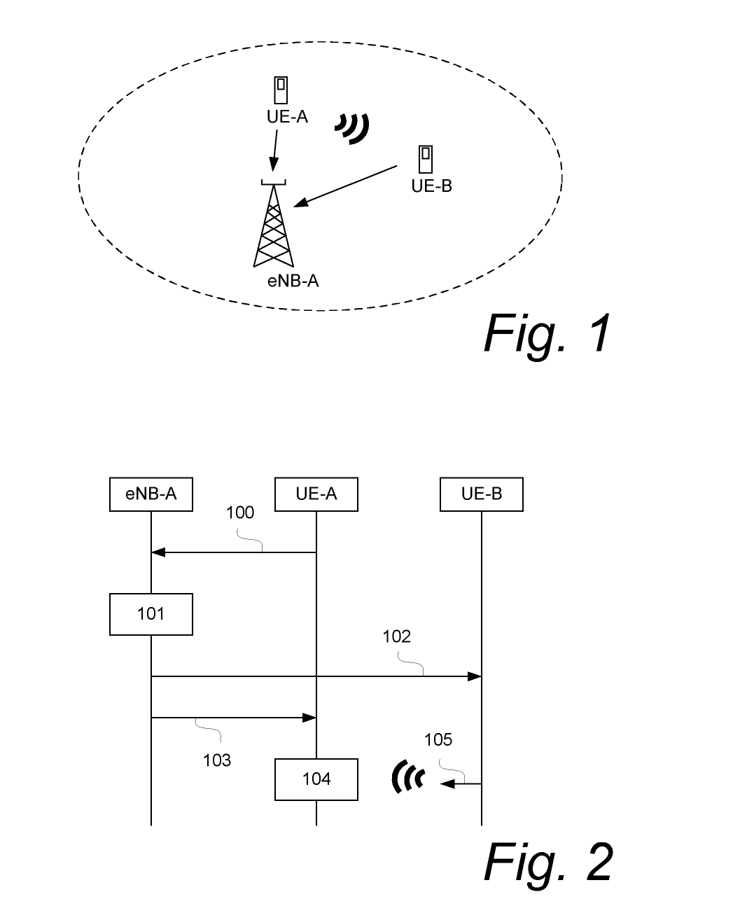

A first embodiment according to the invention will now be described with reference to FIG. 1. FIG. 1 illustrates a first scenario of cellular controlled D2D communication. A first UE, denoted UE-A, and a second UE, denoted UE-B, are residing in the same cell. Or said differently, the two UEs are connected in the same cell. The cell is controlled by a radio network node, here exemplified by the evolved NodeB, eNB-A. The eNB-A is configured to assist in D2D discovery and communication. In this embodiment, it is generally assumed that both UE-A and UE-B are in the so-called RRC Connected State (i.e. Connected mode).

FIG. 2 is a flow chart illustrating a D2D neighbor discovery procedure when neighboring UEs, i.e. the UE-A and the UE-B, are residing in the same cell, which cell is controlled by the eNB-A.

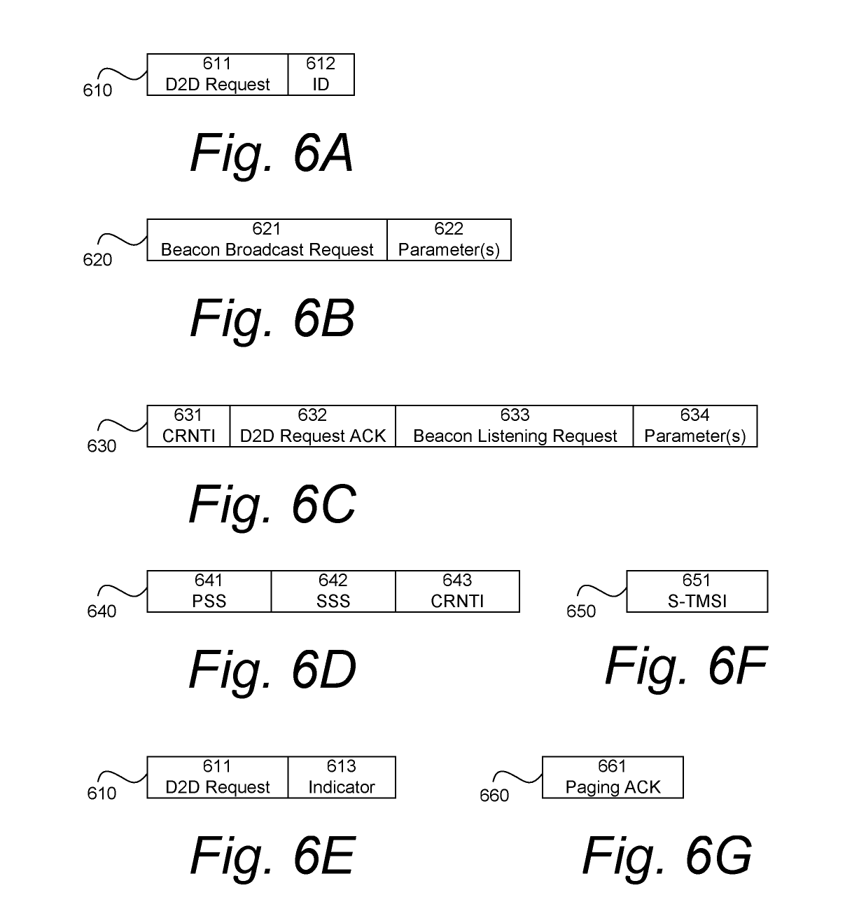

The UE-A sends 100, i.e. transmits, a signal 610 (see FIG. 6A) to an eNB-A which is serving the cellular communication of UE-A. This signal 610 comprises a request 611 to initiate D2D discovery (hereinafter referred to as “D2D request”) with another UE, for example UE-B. Optionally, the signal 610 may comprise one or several additional information elements. In this example embodiment, the signal 610 transmitted by UE-A comprising the D2D request comprises an additional information element 612. This additional information element 612 of the signal 610 comprises an identification (ID) of the UE-B. The identification may, e.g., comprise a Mobile Subscriber Integrated Services Digital Network (MSISDN) number. As is known among persons skilled in the art, the MSISDN number is a number uniquely identifying a subscriber of a UE. The MSISDN can be thought of as a globally unique number of a subscription identity module (SIM) card. Alternatively, the identification may e.g. comprise an International Mobile Subscriber Identity (IMSI). Other UE identifications can of course also be conceived.

The eNB-A receives 100 the above-mentioned signal 610 comprising the D2D request 611 and the ID 612 (e.g. MSISDN, or IMSI). Upon receipt of the signal 610, the eNB-A retrieves 101 the CRNTI of the UE-B. The eNB-A can use existing technology for retrieving the CRNTI of UE-B. For example, eNB-A can retrieve the CRNTI of UE-B from a Home Location Register (HLR) located in the so-called Evolved Packet Core (EPC) network. The eNB-A can e.g. use this CRNTI to address UE-B when transmitting signal 102 (see below).

If, or when, the eNB-A determines, based on the CRNTI of UE-B, that the UE-B is connected to eNB-A, the eNB-A also activates 101 a D2D admission control scheme to establish whether a D2D discovery can take place between the UE-A and the UE-B. As is known among persons skilled in the art, admission control schemes e.g. check whether there are unused radio resources such as physical resource blocks (PRB) in the cell that can be used for beacon transmissions by the UE-B. Using admission control schemes (such as the Radio Admission Control in LTE networks) when setting up radio bearers is known in the art and can be performed according to existing techniques.

If, or when, the admission control scheme indicates that D2D discovery can take place between UE-A and UE-B (e.g., the admission control scheme indicates that resources such as PRBs are available for beacon signal transmission), the eNB-A sends 102, to the UE-B, a signal 620 comprising a request 621 requesting the second UE, i.e. UE-B, to transmit a beacon signal comprising the CRNTI of the UE-B. The signal 620 may optionally comprise one or more additional information elements 622. In this example embodiment, the signal comprises an additional information element 622 comprising one or several useful parameters. Such useful parameters may e.g. include one or more of the following: beacon power level, indication of the physical resource block (PRB) to be used for the beacon signal transmission, modulation and coding scheme (MCS) to be used, the number of times the beacon signal should be transmitted, etcetera.

Also, the eNB-A sends 103 a signal 630 to the first UE, i.e. UE-A, wherein said signal 630 comprises the CRNTI of the second UE, i.e. UE-B. Or more specifically, the signal 630 comprises an information element 631 comprising the CRNTI of UE-B. The signal 103 may optionally comprise an additional information element 632, which in this example embodiment comprises an acknowledgment (ACK) of the earlier-sent D2D request (see FIG. 6C). In this example embodiment, the signal further comprises an information element 633 including a request for requesting the UE-A to listen for beacon signals from the UE-B. In some embodiments, there is no explicit information element 633 including the request for requesting the UE-A to listen for beacon signals from the UE-B. Instead, the D2D Request ACK in information element 632 can function as the request for requesting the UE-A to listen for beacon signals from the UE-B. Optionally, the signal 630 may comprise an additional information element 634 comprising one or several useful parameters. Such useful parameters may e.g. include one or more of the following: indication of the PRB which is used by the UE-B used for the beacon signal transmission (as part of the PDCCH channel (Physical Downlink Control CHannel), the Cell-ID of the cell in which UE-B is located, modulation and channel coding scheme (MCS) to be used for beacon signal transmission, the maximum instances of beacon transmissions, etcetera.

The second UE, that is UE-B, receives 102 the earlier-mentioned signal 620 comprising the Beacon Broadcast Request 621. Upon receipt of such signal 620, the UE-B begins to transmit 105 beacon signals 640. In this example embodiment, the signal 640 comprises both PSS 641 and SSS 642. Using the PSS and the SSS may allow for uniquely identifying the cell in which the UE-B is currently residing, or located. The PSS 641 and the SSS 642 broadcasted, i.e. transmitted, by UE-B comprises generally the same sequence as the PSS and SSS used by eNB-A. Thus, the UE-B is generally capable of using the same cell identity as the eNB-A to construct the beacon signal. However, the Orthogonal Frequency Division Multiplexing, OFDM, symbols that are used by the UE-B for transmitting the beacon signal may be different from the ones used by the eNB-A. Or said differently, UE-B does not necessarily use the same OFDM subcarriers as the eNB-A. In fact, it may be advantages if the UE-B uses different subcarriers, because then any interference between the UE-B and the eNB-A can be avoided. Also in contrast, an information element 643 comprising the CRNTI of the UE-B is provided as an extension to the PSS 641 and SSS 642. Since the PSS 641 and the SSS 642 are generated generally in the same way as ordinary PSS and SSS according to existing procedures, little complexity is added by this embodiment and existing procedures can be reused to a relatively large extent.

The first UE, i.e. UE-A, receives 103 the earlier-mentioned signal 630 from the eNB-A. Also, the UE-A begins to listen for beacon signals 640 (see FIG. 6D) from the UE-B. In this example, the UE-A receives 105 a beacon signal 640 from the UE-B. This beacon signal 640 comprises the information element 643 including the CRNTI of the UE-B as described hereinabove.

If, or when, the UE-A has received the signal 630 from the eNB-A and the beacon signal 640 from the UE-B, the UE-A can compare 104 the CRNTI received in signal 630 with the CRNTI received in the beacon signal 640.

A D2D discovery between the UE-A and the UE-B can thus be established 104 if, or when, the CRNTI received in signal 630 matches the CRNTI received in the beacon signal 640. Or said differently, when the two CRNTIs match each other, the UE-A has made a successful discovery of the UE-B. It is an advantage if the beacon signal 640 comprises the PSS 641 and SSS 642 signals, because this may allow the UE-A to obtain synchronization to the UE-B as part of the D2D discovery procedure.

However, when it is determined in the comparison 104 that the CRNTI received in signal 630 does not match the CRNTI received in the beacon signal 640 the UE-A does not process the beacon signal further. In other words, the D2D discovery procedure is discontinued if the two CRNTI's does not match with each other. In some embodiments, the UE-A comprises a timer. If so, the UE-A may be configured to start the timer, e.g., upon reception of the two CRNTIs and D2D communication establishment, or set-up, is discontinued when the timer has reached a pre-defined maximum time limit (e.g. 30, 45, 60 or 90 seconds) without finding a match between the two CRNTIs. The exact time to be pre-set, or pre-defined, as the maximum time limit can be tested and evaluated in each specific case and in accordance with certain needs. Also, the timer may be embodied as software, hardware or a combination of both hardware and software.

In the above-mentioned embodiment described with respect to FIG. 1, the signal 610 (see FIG. 6A) comprises an information element 612 including an ID of the UE-B, e.g. the MSISDN number as described earlier. In alternative embodiments, the signal 610 does not include any ID of the UE-B. In such alternative embodiments, the user of the UE-A does not have any a priori desired UE-B and may not know the identification (e.g. MSISDN number) of the UE-B. For example, the user of UE-A may be interested in certain service(s) and/or content and may be interested to check whether there is any UE or UEs located in close proximity that could provide such service(s) and/or content to the UE-A. In such embodiments, the signal 610 may take a different form as illustrated in FIG. 6E instead. The signal thus comprises a first information element 611 including the D2D request. Additionally, an information element 613 comprises an indicator, which is indicating a type of D2D communication. That is, the indicator indicates the type of D2D communication the UE-A is desiring, or more particularly, the user of the UE-A is desiring. The type of communication may be a service and/or a content. Consequently, the indicator may be embodied as a content ID and/or a service ID identifying the content and/or service, respectively. Also, the indicator may be selected by the user by operating a user interface (UI) of the UE-A.

The eNB-A may store a list of services and/or contents (e.g. in the form of content ID and/or service ID) that can be provided by any of the UEs residing in the cell (i.e. connected to the cell) that is controlled by eNB-A. The eNB-A may also have a list of services and/or contents that can be provided by any of the UEs in a same tracking area in which the eNB-A is located. Thus, the eNB-A can check whether there exists any UE-B in this cell (or in the tracking area) that is capable of providing the requesting UE-A with its desired service and/or content. The paper “Design Aspects of Network Assisted Device-to-Device Communications” by Gábor Fodor et al published in the IEEE Communications Magazine (May, 2011) describes a registration procedure that allows the eNB to know what kind of services and/or content are available by D2D-capable UEs in the cell in question, or in the tracking area.

Embodiments where UEs are Camping in the Same Cell (IDLE MODE)

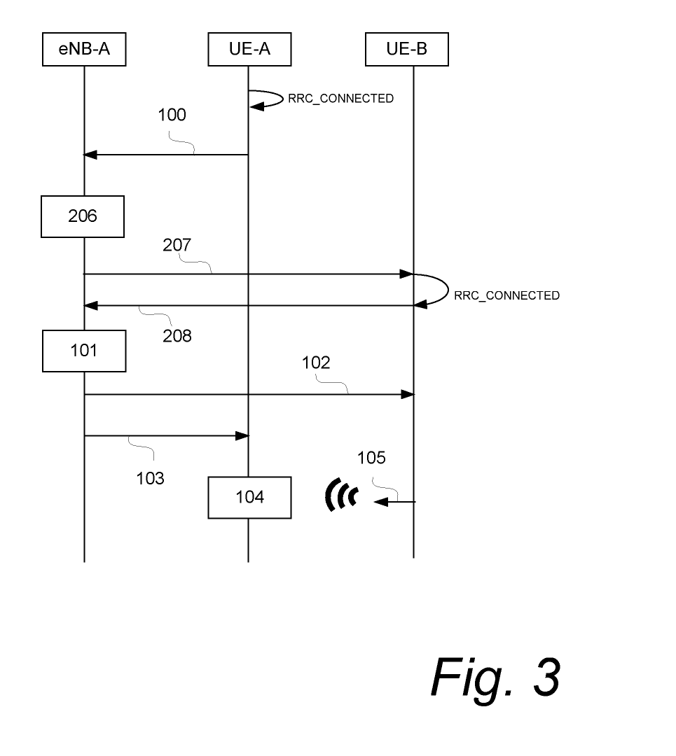

Another embodiment will now be described also with reference to FIG. 1 and FIG. 3. Again, FIG. 1 illustrates a scenario of cellular controlled D2D communication. A first UE, denoted UE-A, and a second UE, denoted UE-B, are residing in the same cell. The cell is controlled by a radio network node, here exemplified by the evolved NodeB, eNB-A. The eNB-A is configured to assist in D2D discovery and communication. In this embodiment, it is generally assumed that both UE-A and UE-B are in the so-called IDLE mode initially. In this condition, the UEs are only synchronized with the Paging Channel, PCH. Both UEs are capable of D2D communication and their respective D2D capability may be registered at the Mobility Management Entity, MME, that is controlling the tracking area in which the UE-A and UE-B are located.

FIG. 3 is a flow chart illustrating a D2D neighbor discovery procedure when UE-A and UE-B are camping in the same cell, which is controlled by the eNB-A, and wherein both UEs are initially considered to be in IDLE mode. The procedure disclosed in FIG. 3 is similar to the procedure described with reference to FIG. 2. Like reference numbers therefore refer to like elements in FIG. 2 and FIG. 3. Also, in order to ease the understanding of the embodiment shown in FIG. 3, only those steps that differ between the two procedures will be detailed hereinbelow.

The UE-A initially performs a random access procedure. Performing a random access procedure is known in the art and will therefore not be further detailed herein. After the UE-A has performed the random access procedure, the UE-A is in the RRC Connected state, i.e. Connected mode.

Upon reception 100 of a signal 610 (comprising the D2D request 611 and optionally the ID 612 of the UE-B) from UE-A, the eNB-A retrieves 206 a SAE-Temporary Mobile Subscriber Identity, S-TMSI, of the UE-B, in order to page the UE-B (which is currently in RRC Idle (i.e. idle mode)). That is, a CRNTI of the UE-B is not yet registered at eNB-A. The eNB-A may use existing technology to retrieve the S-TMSI used for paging of the UE-B. For example, the S-TMSI can be retrieved from the MME and/or the HLR located in the EPC network. Alternatively, or additionally, the eNB-A may use a specific content ID (and/or service ID) to page UE-B or any other UEs that can provide the content (and/or service) specified by the content ID (and/or service ID). Or said differently, along with the S-TMSI (or instead of the S-TMSI), the eNB-A may use a specific content ID to page UE-B or any other UEs that can provide the content specified by the content ID.

Subsequently, the eNB-A may send 207 a paging message 660 comprising an information element including the retrieved S-TMSI of the second UE, i.e. UE-B Additionally, or alternatively, the paging message 660 may comprise a certain content ID and/or service ID.

As mentioned hereinabove, the UE-B is initially in RRC Idle (i.e. idle mode). The UE-B can thus use existing techniques to monitor the Physical Downlink Control Channel (PDCCH) for a Paging Radio Network Temporary Identifier (PRNTI) that indicates the paging transmission potentially containing the SAE-Temporary Mobile Subscriber Identity (S-TMSI) number of UE-B or alternatively a content ID and/or service ID that UE-B can provide. For a more detailed description of this, see for example the Technical Specification 3GPP TS 36.331 V.11.1.0 (2012-09).

Upon reception 207 of a paging message, the UE-B may decode the PDCCH and check if the UE identity included in the paging message matches the S-TMSI assigned to UE-B by the Evolved Packet Core (EPC) in the tracking area. Alternatively, the UE-B checks if the content ID and/or service ID included in the paging message matches the content ID and/or service ID that the UE-B can provide.

When the UE-B compares the S-TMSI received in the signal 650 with the S-TMSI assigned to the UE-B and determines that there is a match between the two S-TMSI's (or, alternatively, and the two content IDs and/or service IDs), the UE-B may process the paging message and, furthermore, perform a random access procedure to switch to RRC Connected (i.e. connected mode). Once the UE-B is in RRC Connected, the UE-B may send 208 a paging acknowledgment message 660 to the eNB-A. This message 660 may thus indicate, to the eNB-A, the availability to be discovered for D2D communication.

Upon reception 208 of the paging acknowledgement message 660, the method may continue in the same way as described with reference to steps 101 through 105 described with respect to FIG. 2.

User Equipments

FIG. 4 is a block diagram of a user equipment (UE) 400 according to an example embodiment of the present invention. The term UE as used in this disclosure comprises any device, which can be used by a user to communicate. As such, the UE 400 may be a mobile terminal. More particularly, the UE 400 may be a mobile communication terminal. The term mobile communication terminal includes devices such as mobile telephones (also knows as cellular phones, cellphones, smartphones, etc.), tablet computers and the like.

As is illustrated in FIG. 4, the UE 400 comprises a communication interface 410, a processor 420 and a memory 430. The UE 400 may also comprise a user interface, UI, 440 through which the user may operate and interact with the UE 400. The processor 420 may be provided using any suitable central processing unit (CPU), microcontroller, digital signal processor (DSP), etc., capable of executing computer program comprising computer program code, the computer program being stored in the memory 430. The memory 430 may be any combination of random access memory (RAM) and read only memory (ROM). The memory may also comprise persistent storage, which, for example, can be any single one or combination of magnetic memory, optical memory, or solid state memory or even remotely mounted memory. The communication interface 410 is configured for wireless communication. To this end, the communication interface may comprise a transmitter and a receiver. Alternatively, the communication interface 410 may comprise a transceiver.

In this example embodiment, the memory 430 stores computer program code which, when run in the processor 420, causes the UE 400 to send, to a radio network node via the communication interface 410, a signal comprising a request to initiate D2D communication with a second UE; receive, from the radio network node via the communication interface 410, a signal comprising a CRNTI of the second UE; receive, from the second UE via the communication interface 410, a beacon signal comprising the CRNTI of the second UE; compare the CRNTI of the second UE received by the radio network node with the CRNTI comprised in the beacon signal received from the second UE; and establish, via the communication interface 410 a device-to-device communication between the first UE and the second UE when the CRNTI of the second UE received by the radio network node matches the CRNTI comprised in the beacon signal received from the second UE.

The signal received from the second UE comprising the C-RNTI may further comprise a Primary Synchronization Signal, PSS. Additionally, or alternatively, this signal received from the second UE comprising the C-RNTI may comprise a Secondary Synchronization Signal, SSS.

The signal comprising the CRNTI of the second UE, which can be received from the radio network node, may additionally comprise a request for requesting the UE 400 to listen for beacon signals from the second UE.

Also, the signal which is sent to the radio network node and which comprises the request to initiate D2D communication with the second UE may additionally comprise an identification of the second UE. This identification may e.g. comprise a MSISDN number or an IMSI number, or even both. Additionally, or alternatively, the signal which is sent to the radio network node and which comprises the request to initiate D2D communication with the second UE comprises an indicator indicating a type of D2D communication. The type of D2D communication may, for instance, be a service and/or content.

Moreover, the memory 430 and the computer program code may be configured to, together with the processor 420, further cause the UE 400 to receive (via the communication interface 410) a paging message from the radio network node, the paging message comprising a S-TMSI (and/or a content ID and/or a service ID); to compare the thus received S-TMSI (and/or content ID and/or service ID) with an already assigned S-TMSI (and/or content ID and/or service ID that UE 400 can provide); and if the two S-TMSI's (and/or the two content IDs and/or service IDs) match each other furthermore to return (i.e. transmit via communication interface 410) a paging acknowledgment message to the radio network node.

Yet further, the memory 430 and the computer program code may be configured to, with the processor 420, further cause the UE 400 to send (via communication interface 410) a beacon signal comprising the CRNTI of the first UE to another UE. For example, the memory 430 and the computer program code may be configured to, with the processor 420, further cause the UE 400 to send this beacon signal comprising the CRNTI of the first UE to said another UE upon receiving a request from a radio network node requesting the first UE to send said beacon signal.

Radio Network Nodes

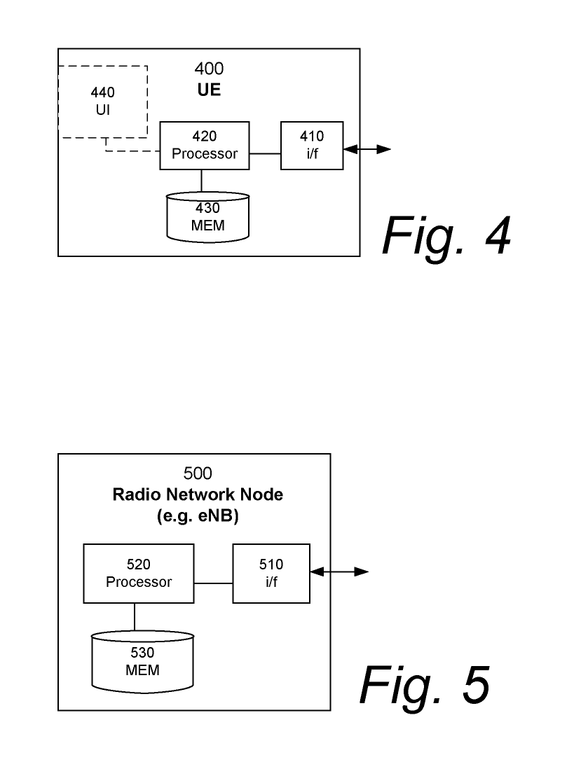

FIG. 5 is a block diagram of a radio network node 500 according to an example embodiment of the present invention. The radio network node is exemplified as an evolved NodeB, eNB. The eNB is the element in E-UTRA of LTE that is the evolution of the element Node B in UTRA of the UMTS. It can be said to represent the hardware that is connected to the telecommunication network that communicates directly with UEs, like a base transceiver station (BTS) in GSM telecommunication networks (Global System for Mobile Communications).

As is illustrated in FIG. 5, the radio network node 500 comprises a communication interface 510, a processor 520 and a memory 530. The processor 520 may be provided using any suitable central processing unit (CPU), microcontroller, digital signal processor (DSP), etc., capable of executing computer program comprising computer program code, the computer program being stored in the memory 530. The memory 530 may be any combination of random access memory (RAM) and read only memory (ROM). The memory may also comprise persistent storage, which, for example, can be any single one or combination of magnetic memory, optical memory, or solid state memory or even remotely mounted memory. The communication interface 510 is configured for wireless communication. To this end, the communication interface may comprise a transmitter and a receiver. Alternatively, the communication interface 510 may comprise a transceiver.

In this example embodiment, the memory 530 stores computer program code which, when run in the processor 520, causes the radio network node 500 to: receive, from a first UE (via the communication interface 510) a signal comprising a request to initiate D2D communication with a second UE; retrieve a CRNTI of the second UE; activate a D2D admission control scheme to establish whether a D2D communication can take place between the first UE and the second UE; and when the admission control scheme indicates that a D2D communication can take place between the first UE and the second UE also send, to the first UE (via the communication interface 510), a signal comprising a CRNTI of the second UE.

The signal comprising the CRNTI of the second UE which is sent to the first UE may further comprise a request requesting the first UE to listen for beacon signals from a second UE.

The signal received from the first UE comprising the request to initiate device-to-device communication with the second UE may additionally comprise an identification of the second UE. For instance, the identification may comprise a MSISDN number or an IMSI number. Additionally, or alternatively, the signal received from the first UE comprising the request to initiate device-to-device communication with the second UE additionally comprises an indicator indicating a type of D2D communication.

Furthermore, the memory 530 and the computer program code may be configured to, with the processor 520, further cause the radio network node 500 to retrieve (e.g. via communication interface 510) a S-TMSI of the second UE (and/or a content ID and/or service ID); to send via the communication interface 510 a paging message to the second UE, the paging message comprising the earlier-retrieved S-TMSI (and/or a content ID and/or service ID); and to receive, via the communication interface 510, a paging acknowledgement message from the second UE.

Moreover, the memory 530 and the computer program code may be configured to, with the processor 520, to further cause the radio network node 500 to send, via the communication interface 510 to the second UE, a signal comprising a request requesting the second UE to transmit a beacon signal comprising a CRNTI of the second UE.

The various embodiments of the present invention discussed in this disclosure provide for a facilitated process of setting up, or establishing, D2D communication between UEs that are located in close proximity to each other. The various embodiments allow to discover D2D-capable UEs by exploiting the CRNTI assigned to UEs. According to some embodiments, D2D-capable UEs can be discovered by exploiting the CRNTI assigned to any UE in combination with the PSS and SSS signaling mechanism. The various embodiments of the present invention add very little complexity. The CRNTIs are already available and so are the PSS and SSS signaling mechanisms. Thus, existing concepts can be reused although in a slightly different way and for a different purpose, namely to provide an alternative and improved D2D neighbor discovery. Furthermore, the various embodiments of the present invention may allow for D2D-capable UEs to discover any of very many devices, such as more than 504 devices in accordance with some embodiments. For example, some embodiments leverages both the PSS/SSS (504 identities) scheme and the CRNTI (16 bits). That is, both a cell specific identifier (i.e. PSS/SSS) and a unique identifier within the cell (i.e. CRNTI) are utilized. This may allow for discovering a UE among many D2D-capable UEs during a D2D neighbor discovery, such considerably more than 504 D2D-capable UEs. Providing a capability of discovering a UE among many D2D-capable UEs during a D2D neighbor discovery may become increasingly important in the future when it is foreseen that very many devices and potentially as many as one billion devices are becoming connectable. In the vision of one billion connected devices, the existing neighbor discovery procedures may not be flexible enough. However, using CRNTIs in accordance with the embodiments of this invention can provide a more flexible D2D discovery which is computationally feasible even for a large number of UEs. Further, thanks to some of the embodiments of this invention a large number of D2D-capable UEs can be active at the same time and only the desired UEs needs to be discovered (e.g. by identification such as MSISDN, IMSI or by service and/or content).

In the detailed description hereinabove, for purposes of explanation and not limitation, specific details are set forth such as particular architectures, interfaces, techniques, etc. in order to provide a thorough understanding of various embodiments of the present invention. In some instances, detailed descriptions of well-known devices, circuits, and methods have been omitted so as not to obscure the description of the embodiments disclosed herein with unnecessary detail. All statements herein reciting principles, aspects, and embodiments disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that block diagrams herein can represent conceptual views of illustrative circuitry or other functional units embodying the principles of the embodiments. Similarly, it will be appreciated that any flow charts and the like represent various processes which may be substantially represented in computer readable medium and so executed by a computer or processor, whether or not such computer or processor is explicitly shown. The functions of the various elements including functional blocks, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions. In terms of computer implementation, a computer is generally understood to comprise one or more processors or one or more controllers. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

Although the present invention has been described above with reference to specific embodiments, it is not intended to be limited to the specific form set forth herein. Rather, the invention is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

1-19. (canceled)

20. A method performed by a first user equipment (UE), the method comprising:
sending a signal to a radio network node, the signal comprising a request to initiate device-to-device communication with a second UE;
receiving, from the radio network node, a signal comprising a Cell Radio Network Temporary Identifier (CRNTI) of the second UE;
receiving, from the second UE, a beacon signal comprising the CRNTI of the second UE;
comparing the CRNTI of the second UE received from the radio network node with the CRNTI from the beacon signal received from the second UE; and
establishing a device-to-device communication between the first UE and the second UE in response to the CRNTI of the second UE received from the radio network node matching the CRNTI from the beacon signal received from the second UE.

21. The method of claim 20, wherein the beacon signal received from the second UE further comprises a Primary Synchronization Signal (PSS) and a Secondary Synchronization Signal (SSS).

22. The method of claim 20, wherein the signal comprising the CRNTI of the second UE, received from the radio network node, additionally comprises a request for requesting the first UE to listen for beacon signals from a second UE.

23. The method of claim 20, wherein the signal sent to the radio network node comprising the request additionally comprises an identification of the second UE.

24. The method of claim 23, wherein the identification of the second UE comprises a Mobile Subscriber Integrated Services Digital Network (MSISDN) number or an International Mobile Subscriber Identity (IMSI) number.

25. The method of claim 20, wherein the signal sent to the radio network node comprising the request additionally comprises an indicator indicating a type of device-to-device communication.

26. The method of claim 20, further comprising:
receiving a paging message from a radio network node, the paging message comprising a System Architecture Evolution Temporary Mobile Subscriber Identity (S-TMSI) of the first UE;
comparing the S-TMSI of the first UE received from the radio network node with a S-TMSI assigned to the first UE; and
sending a paging acknowledgment message to the radio network node in response to the S-TMSI of the first UE received from the radio network node matching the S-TMSI assigned to the first UE.

27. The method of claim 20, further comprising sending a beacon signal comprising the CRNTI of the first UE to another UE in response to receiving another request from the radio network node, the another request requesting the first UE to send the beacon signal.

28. The method of claim 27, wherein the beacon signal comprising the CRNTI of the first UE additionally comprises a Primary Synchronization Signal (PSS) and a Secondary Synchronization Signal (SSS).

29. A method performed by a radio network node, the method comprising:
receiving a signal from a first user equipment (UE), the signal comprising a request to initiate device-to-device communication with a second UE;
retrieving a Cell Radio Network Temporary Identifier (CRNTI) of the second UE;
activating a device-to-device admission control scheme to establish whether a device-to-device communication can take place between the first UE and the second UE;
in response to the admission control scheme indicating that a device-to-device communication can take place between the first UE and the second UE, sending, to the first UE, a signal comprising a CRNTI of the second UE.

30. The method of claim 29, wherein the signal comprising the CRNTI of the second UE which is sent to the first UE further comprises a request requesting the first UE to listen for beacon signals from a second UE.

31. The method of claim 29, wherein the signal received from the first UE comprising the request to initiate device-to-device communication with the second UE comprises an identification of the second UE.

32. The method of claim 31, wherein the identification of the second UE comprises a Mobile Subscriber Integrated Services Digital Network (MSISDN) number or an International Mobile Subscriber Identity (IMSI) number.

33. The method of claim 29, wherein the signal received from the first UE comprising the request to initiate device-to-device communication with the second UE additionally comprises an indicator indicating a type of device-to-device communication.

34. The method of claim 29, further comprising:
retrieving a System Architecture Evolution Temporary Mobile Subscriber Identity (S-TMSI) of the second UE;
sending a paging message to the second UE, the paging message comprising the retrieved S-TMSI of the second UE; and
receiving a paging acknowledgment message from the second UE;
wherein the activating the device-to-device admission control scheme is performed when the paging message has been received.

35. The method of claim 29, further comprising sending, to the second UE, a signal comprising a request requesting the second UE to transmit a beacon signal comprising a CRNTI of the second UE.

36. A user equipment, comprising:
a communication interface configured for wireless communication;
a processing circuit; and
memory storing computer program code which, when run by the processor, causes the user equipment to:
send, to a radio network node and via the communication interface, a signal comprising a request to initiate device-to-device communication with a second UE;
receive, from the radio network node and via the communication interface, a signal comprising a Cell Radio Network Temporary Identifier (CRNTI) of the second UE;
receive, from the second UE and via the communication interface, a beacon signal comprising the CRNTI of the second UE;
compare the CRNTI of the second UE received from the radio network node with the CRNTI from the beacon signal received from the second UE; and
establish, via the communication interface, a device-to-device communication between the first UE and the second UE in response to the CRNTI of the second UE received from the radio network node matching the CRNTI from the beacon signal received from the second UE.

37. A radio network node, comprising:
a communication interface configured for wireless communication;
a processing circuit; and
memory storing computer program code which, when run by the processing circuit, causes the radio network node to:
receive, from a first user equipment (UE) and via the communication interface, a signal comprising a request to initiate device-to-device communication with a second UE;
retrieve a Cell Radio Network Temporary Identifier (CRNTI) of the second UE;
activate a device-to-device admission control scheme to establish whether a device-to-device communication can take place between the first UE and the second UE; and
in response to the admission control scheme indicating that a device-to-device communication can take place between the first UE and the second UE, send, to the first UE and via the communication interface, a signal comprising a CRNTI of the second UE.

38. The radio network node of claim 37, wherein the radio network node is a evolved NodeB.
